(19) United States
(12) Patent Application Publication
(10) Pub. No.: US 2007/0264558 A1
(43) Pub. Date: Nov. 15, 2007

(54) FLOW BOARD WITH CAPILLARY FLOW STRUCTURE FOR FUEL CELL

(76) Inventors: Hsi-Ming Shu, Taipei (TW); Wei-Li Huang, Taipei (TW)

Correspondence Address: G. LINK CO., LTD., 3550 BELL ROAD, MINOOKA, IL, 60447, US

(21) Appl. No.: 11/382,603

(22) Filed: May 10, 2006

(51) Int. Cl. H01M 8/02

(52) U.S. Cl. 429/38

(57) ABSTRACT

A flow board with a capillary flow structure for a fuel cell comprises a substrate and capillary flow channels. Each of the capillary flow channels is a small serpentine trench disposed on the surface of the substrate to make the adhesion of liquid fuels in the capillary flow channels greater than the surface tension thereof. Therefore, the liquid fuels are inclined to adhere onto the surface of the capillary flow channels and flow smoothly.

### FIELD OF THE INVENTION

The present invention relates to a structure of a flow board, and more particularly, to a flow board that includes a capillary flow structure and is applied to a fuel cell.

### BACKGROUND OF THE INVENTION

Conventional fuel cells usually utilize redox of hydrogen-containing fuels like methanol to generate power for external loadings. It is essential for such fuel cells to have sufficient fuels, such as methanol. Aside from a flow board and a container for containing liquid fuels, a fuel cell includes a driving mechanism for propelling fuel flow, in order to obtain enough fuel. As such, fuel in the flow board can flow smoothly through the driving mechanism. However, the driving mechanism (e.g. a pump) needs to consume energy (e.g. electricity) and converts this kind of energy into kinetic energy for flowing fuels, wasting much energy sources. Additionally, the use of a pump is unfavorable to the goal of a miniaturized, low cost fuel cell.

Therefore, an improved flow board having a capillary flow structure is needed to overcome the aforesaid disadvantages.

### SUMMARY OF THE INVENTION

It is a primary object of the invention to provide a flow board applied to a fuel cell, in which liquid fuels flow owing to capillarity.

In accordance with the aforesaid object of the invention, a flow board having a capillary flow structure for a fuel cell is provided. The flow board comprises a substrate and capillary flow channels. Each of the capillary flow channels is a small zigzag trench disposed on the surface of the substrate to make the adhesion of liquid fuels in the capillary flow channels greater than surface tension thereof. Accordingly, the liquid fuels are inclined to adhere onto the surface of the capillary flow channels and flow smoothly.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is an exploded elevation view showing a flow board with a capillary flow structure in a fuel cell according to an embodiment of the invention;

FIG. 2 illustrates the cross section of FIG. 1;

FIG. 3 is an elevation view showing a fuel cell employing a flow board in accordance with an embodiment of the invention;

FIG. 4 illustrates a top view of a flow board according to another embodiment of the invention;

FIG. 5 through FIG. 7 separately shows that a flow board in accordance with an embodiment of the invention is cooperated with other associated components; and

FIG. 8 illustrates a top view of a flow board having an electrical component according to an embodiment of the invention.

### DETAILED DESCRIPTION OF THE INVENTION

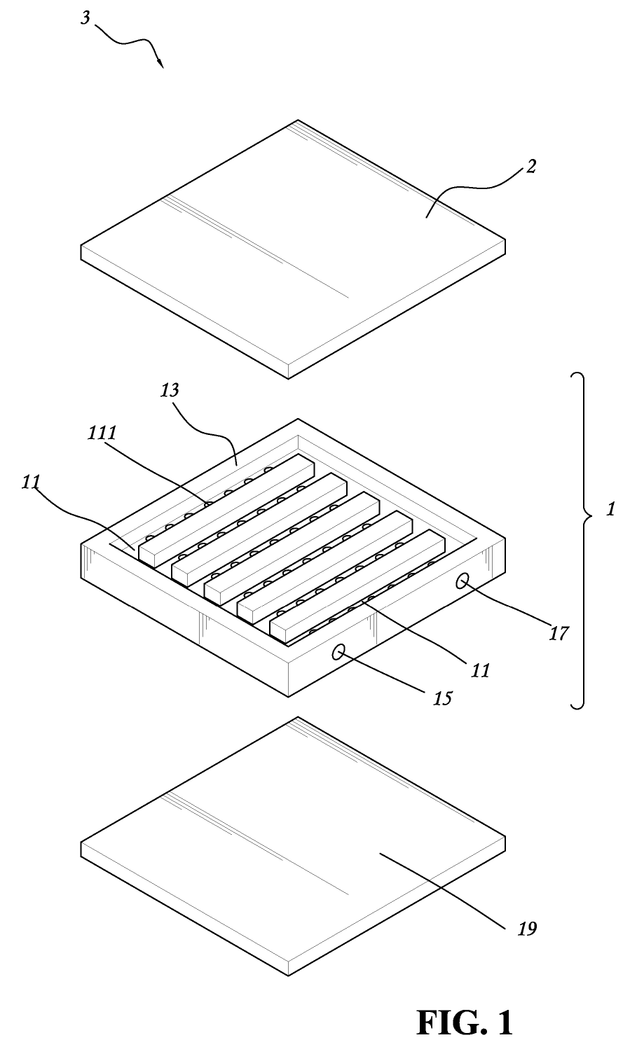

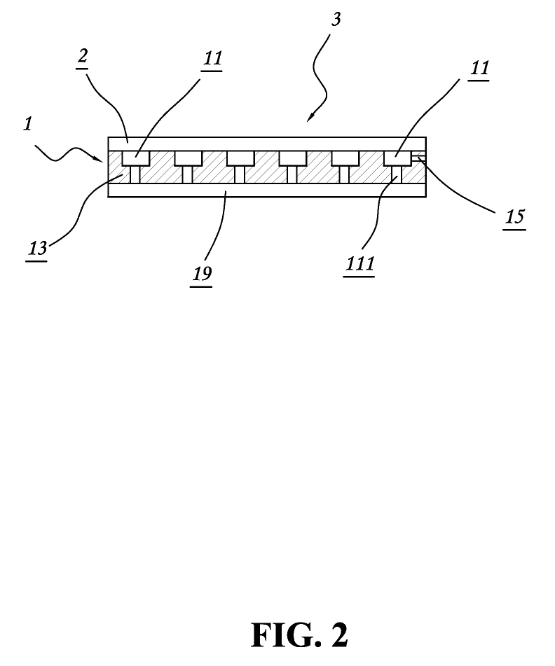

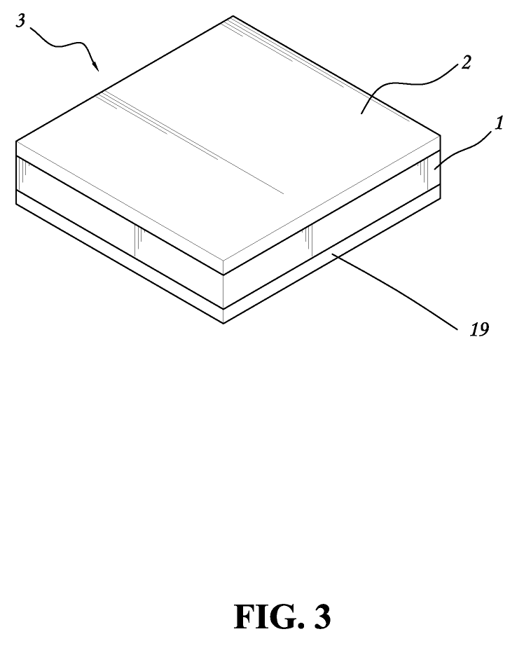

FIG. 1 is an exploded elevation view showing a flow board with a capillary flow structure in a fuel cell according to an embodiment of the invention. FIG. 2 illustrates the cross section of FIG. 1. FIG. 3 is an elevation view showing a fuel cell employing a flow board in accordance with an embodiment of the invention. A flow board 1 with a capillary flow structure is a part of a fuel cell 3. A fuel cell board 2 is compactly adhered to the flow board 1, so as to form the fuel cell 3. External liquid fuels flow into the flow board 1 from an inlet 15, pass through capillary flow channels 11, and flow away from an outlet 17. The adhesion of liquid fuels inside the capillary flow channels 11 is greater than the surface tension of its own due to the intrinsic structure of the capillary flow channels 11. Hence, liquid fuels are inclined to adhere onto the surface of the capillary flow channels 11 and flow smoothly. Liquid fuels in the capillary flow channels 11 flow into the inner of the fuel cell board 2 as well.

The flow board 1 comprises the capillary flow channels 11 and a substrate 13. The capillary flow channels 11 may be serpentine trenches averagely disposed on the surface of the substrate 13. Or, the capillary flow channels 11 may include a plurality of separate trenches averagely disposed corresponding to membrane electrode assemblies (not shown) and those trenches converge towards the same outlet. The structure and size of the trench is designed to make liquid fuels therein have an adhesive force greater than its surface tension.

The capillary flow channels 11 further include a plurality of vents 111 to exhaust gaseous products out, which are usually produced when the fuel cell board 2 performs electrochemical reactions. The vents 111 penetrate through the substrate 13, and are disposed along the capillary flow channels 11 averagely. Thus, gaseous products are exhausted through the vents 111. Additionally, the vents 111 prevent gaseous products from inducing bubbles that may jam the capillary flow channels 11 and block liquid fuels from flowing.

Moreover, the opposite surface of the substrate 13 is covered by a gas permeable but liquid impermeable film 19 to allow gaseous products to pass through and prevent liquid fuels from outflowing.

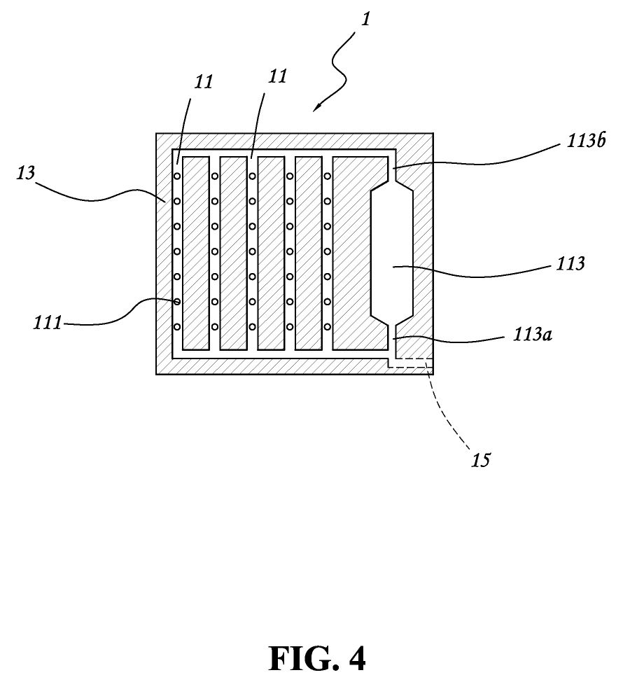

FIG. 4 illustrates a top view of a flow board according to another embodiment of the invention. In this embodiment, a mixing tank 113 is disposed on the surface of the substrate 11. The mixing tank 113 may include a concave structure. A first input 113a of the mixing tank 113 is connected with an common end of the capillary flow channels 11 and the inlet 15, and a second input 113b is connected to another common end of the capillary flow channels 11.

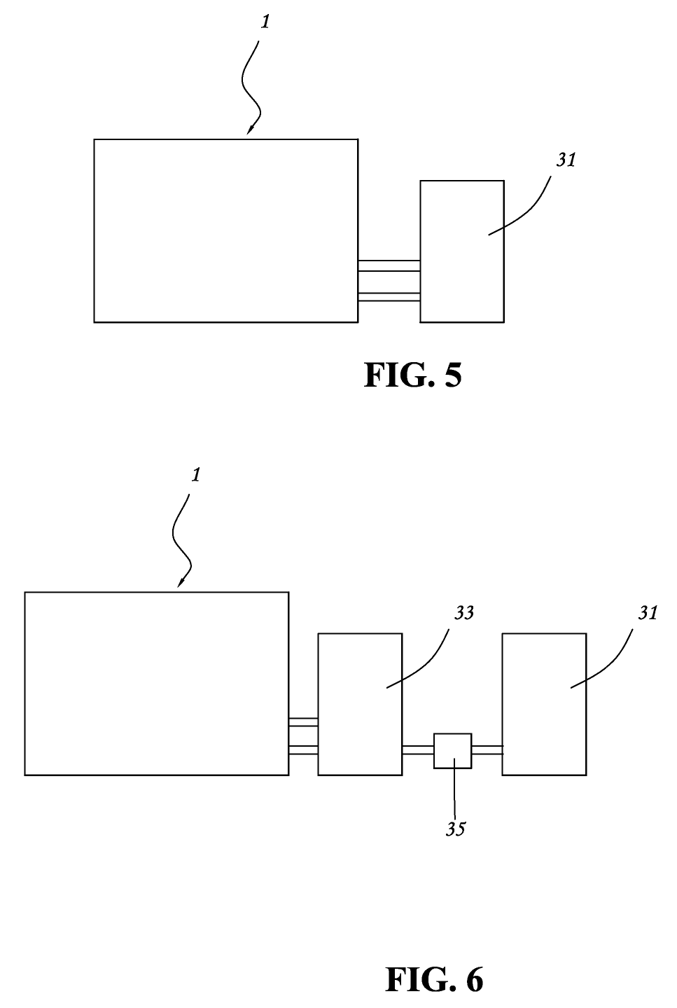

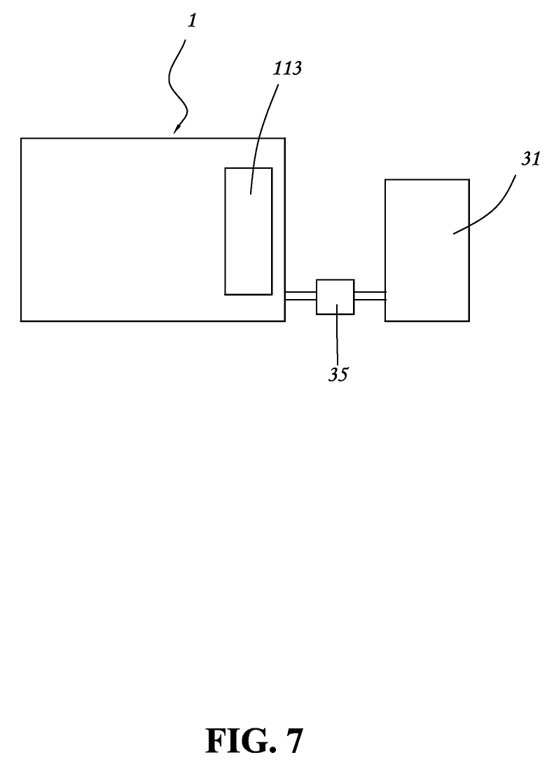

FIG. 5 through FIG. 7 respectively show that flow boards in accordance with embodiments of the invention are cooperated with other associated components. Referring to FIG. 5, a flow board 1 is cooperated with an external fuel tank 31. As shown in FIG. 6, a flow board 1 is cooperated with an external mixing tank 33 and an external fuel tank 31. In FIG. 7, a flow board 11 having an internal mixing tank 113 therein is cooperated with an external fuel tank 31.

The external fuel tank 31 is provided to store liquid fuels with high concentration, such as concentrated methanol. Such liquid fuels with high concentration then flow into the external mixing tank 33 for mixing the same with liquid fuels with low concentration, and the mixed fuels are guided to the capillary flow channels 11. The external mixing tank 33 and the internal mixing tank 113 are provided to recycle anodic products (e.g. water) and residual liquid fuels.

The substrate 13 is made of, for example, an epoxy glass fiber substrate, a polymer plastic substrate, or a ceramic substrate. Alternatively, the substrate 13 may be made of acid-proof/anticorrosive materials. Preferably, the adopted material is further processed to roughen its surface for greater surface adhesion.

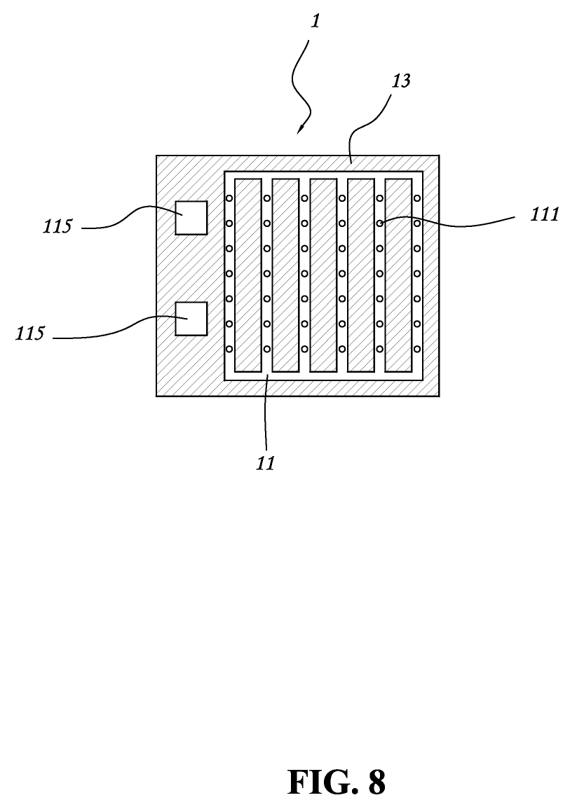

FIG. 8 illustrates a top view of a flow board having an electrical component according to an embodiment of the invention. In order to monitor the status of liquid fuels in the flow board 1, such as fuel concentration, fuel temperature or fuel level, at least an electrical component 115 is disposed on an adequate position of the substrate 13. An exemplar of the electrical components 115 may include a concentration sensor, a temperature sensor, a level sensor, a microcontroller, and etc.

Furthermore, a valve 35 is disposed between the external fuel tank 31 and the mixing tank 33 or 113. The valve 35 is generally closed. As the electrical component 115 detects a concentration of liquid fuels inside the flow board 11 lower than a predetermined value, the valve 35 is opened automatically. Meanwhile, liquid fuels with high concentration stored in the external fuel tank 31 flow into the mixing tank 33 or 113 for mixing the same with liquid fuels existent in the mixing tank 33 or 113. If the electrical component 115 detects a concentration of liquid fuels inside the flow board 1 consistent with a predetermined value, the valve 35 is responsively closed.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A flow board with a capillary flow structure for a fuel cell, the flow board comprising:
a substrate; and
at least one capillary flow channel including a small trench disposed on a surface of the substrate, wherein the capillary flow channels makes liquid fuels in the capillary flow channels have an adhesive force greater than a liquid surface tension such that the liquid fuels adhere onto a surface of the capillary flow channels and flow.

2. The flow board of claim 1, further comprising:
an inlet disposed on a side of the substrate and connected to one common end of the capillary flow channels; and
an outlet disposed on a side of the substrate and connected to another common end of the capillary flow channels.

3. The flow board of claim 2, further comprising:
an inlet disposed on a side of the substrate; and
a mixing tank disposed on the surface of the substrate, wherein the mixing tank comprises a first input connected with one common end of the capillary flow channels and the inlet, and a second input connected with another common end of the capillary flow channels.

4. The flow board of claim 1, further comprising at least an electrical component disposed on the substrate.

5. The flow board of claim 4, wherein the electrical components comprise a sensor.

6. The flow board of claim 1, wherein the capillary flow channels comprise a plurality of vents penetrating through the substrate and are disposed along the capillary flow channels averagely.

7. The flow board of claim 1, further comprising a gas permeable but liquid impermeable film covering another surface of the substrate.

8. The flow board of claim 1, wherein a material of the substrate is selected from a group consisting of an epoxy glass fiber substrate, a polymer plastic substrate, and a ceramic substrate.

9. The flow board of claim 1, wherein a material of the substrate is acid-proof and anticorrosive.

10. The flow board of claim 9, wherein the material comprises a rough surface.

11. The flow board of claim 1, wherein the liquid fuels comprise a solution containing hydrogen.

12. The flow board of claim 1, wherein the liquid fuels are methanol.

13. The flow board of claim 1, wherein the capillary flow channels are zigzag disposed on the surface of the substrate.

14. The flow board of claim 1, wherein the capillary flow channels are averagely disposed on the surface of the substrate corresponding to all membrane electrode assemblies of a fuel cell board.
